(19) United States
(12) Patent Application Publication
(10) Pub. No.: US 2008/0018838 A1
(43) Pub. Date: Jan. 24, 2008

(54) Color filter substrate, color liquid crystal display device using the same, and method for repairing the same

(75) Inventor: Takeya Shimizu, Kawasaki (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KAWASAKI (JP)

(21) Appl. No.: 11/826,564

(22) Filed: Jul. 17, 2007

(30) Foreign Application Priority Data
Jul. 24, 2006 (JP) 2006-201347

(51) Int. Cl. G02F 1/1335; B05D 3/00

(52) U.S. Cl. 349/106; 427/140

(57) ABSTRACT

A color filter substrate includes a transparent substrate, a lower transparent electrode disposed on the transparent substrate, a colored layer disposed on the lower transparent electrode in a display area, and an upper transparent electrode disposed on the colored layer and electrically connected to the lower transparent electrode.

### BACKGROUND OF THE INVENTION

1. Field of the Invention

The present invention relates to a color filter substrate, a color liquid crystal display device using the color filter substrate, and a method for repairing the same. In particular, the present invention relates to a design and a method that permits repairing a defect that occurs when a foreign substance enters a display unit.

2. Description of the Related Art

Color liquid crystal display devices normally include a color filter substrate provided with colored layers of a plurality of colors, an array substrate facing the color filter substrate, and a liquid crystal layer filled and sealed between these substrates. Colors are displayed by controlling transmittance of a part of the liquid crystal layer at a position corresponding to each of the colored layers.

FIG. 8 is a cross-sectional view of a color filter substrate for a conventional color liquid crystal display device. The conventional color filter substrate 60 includes first, a black matrix (hereinafter referred to as a BM) 63 formed in a lattice on a glass substrate 61 as a light shielding film. Next, photosensitive colored resins containing pigments of red (R), green (G), and blue (B) colors are applied to the glass substrate 61, so that colored layers 64 to 66 are formed. Over these layers, an indium-tin-oxide (ITO) film 67 is formed as a transparent electrode. In this way, the color filter substrate 60 is fabricated in a fine lattice-like pattern by photolithography.

However, there is a problem that a foreign substance may enter the colored layers for pixels when fabricating such a color filter substrate. Such a foreign substance consists mainly of particles floating in a clean room, and polymeric materials, metals or the like produced from manufacturing devices. The entering of such a foreign substance could cause a problem such as a short circuit between electrodes of the color filter substrate and a counter substrate, and degradation of display quality.

As a repairing method for removing a foreign substance entering a color filter substrate during its fabrication process, for example, a reference document 1 (Japanese Patent Application Laid-open Publication No. Hei 5-333205) discloses a method in which the foreign substance is removed by mechanically polishing the colored layer. Reference documents 2 and 3 (Japanese Patent Application Laid-open Publications No. 2004-53971 and No. Hei 10-20115) disclose a repairing method in which a foreign substance and a colored layer are removed by irradiating a defective area containing the foreign substance with a laser beam, and in which then a new colored layer is formed again on the defective area.

However, in all the cases of the repairing methods for a color filter substrate disclosed in the above-disclosed reference documents 1 to 3, a color filter substrate containing a foreign substance is required to be repaired before forming an ITO film (an electrode layer for driving liquid crystals) that is the uppermost surface. Then, after the repair, the ITO film needs to be formed on the repaired substrate, but a defect such as the entering of a foreign substance may occur again in this ITO film formation process. For this reason, a completed product of a color filter must be inspected again in a final stage. As such, with any of these methods, the fabrication process requires two inspections. One is an intermediate inspection of detecting defects for repair, and the other is a final inspection on a completed product of a color filter after forming an ITO film. As a result, any of the above-described repairing methods has a problem that such necessity of many inspections may cause an increase in costs.

Alternatively, in a case of omitting an intermediate inspection, a foreign substance may be found in a colored layer in a final inspection. In this case, even when using any of the above-described repairing methods, a common voltage is no longer applied to a repaired region because a colored layer and an ITO film on the repaired region are removed. Consequently, it is necessary to newly form a colored layer and an ITO film on that region. Accordingly, using the above-described repairing methods may increase the number of fabrication processes, which results in a problem of high cost.

Further, when a defect is found on an ITO film in a final inspection, an ITO film of an area containing the defect also needs to be removed. If the repaired region is left without having an ITO film, a common voltage is not applied to that region. Then, an ITO film needs to be newly formed on that region. Accordingly, using the above-described repairing methods may increase the number of fabrication processes, which result in a problem of high cost.

A conventional fabrication process of a color filter substrate will be described below more specifically. FIG. 9 illustrates a flowchart of a fabrication process of the conventional color filter substrate. The conventional fabrication process of a color filter substrate is briefly described below with reference to FIGS. 8 and 9. First, in step S201, the BM 63 is formed on the glass substrate 61 (BM processing) and thereafter, in step S202, each of the colored layers 64 to 66 is formed thereon (RGB processing). Next, in step S203, an intermediate inspection is performed in order to inspect processed results up to this time. When finding a defect at this time, the region containing the defect is repaired in step S204. After repairing the defect or when there is no defect, an ITO film 67 is formed in step S205 (ITO processing). After the ITO processing, a final inspection is performed in step S206. When finding no defect in that step, a fabrication process is terminated in step S207. When finding a defect in that step, the substrate containing the defect is discarded in step S208. Instead, the region having the defect may be repaired, and thereafter the fabrication process may be terminated.

As described above, the conventional fabrication process of a color filter substrate involves two inspections, i.e., the intermediate inspection in step S203 and the final inspection in step S206. Further, in the conventional fabrication process, a defect region of a colored layer is removed and thereafter, on that region, it is necessary to newly form a colored layer. In particular, when defects occur in two or more colored layers of a different color, it is necessary to newly form colored layers of all the colors, so that the number of processes is increased. Alternatively, suppose only a final inspection is performed after the ITO processing in step 205 in the conventional fabrication process, that is, while skipping steps S203 and S204. In that case, when finding a defect in a colored layer, the removal of a colored layer of a region containing the defect causes the ITO film to be removed. The removal of the ITO film means that no common voltage will be applied to the repaired region. For this reason, in the repair, in addition to the forming of a new colored layer on the defect region, an ITO film also needs to be newly formed on the defect region. Hence, in the conventional fabrication process of a color filter, the inspection processes and fabrication processes tend to be increased in number. Accordingly, the burden of repair is also increased, which results in a problem of high cost.

In addition, a reference document 4 (Japanese Patent Application Laid-Open Publication No. Hei 8-201621) discloses a color filter that disposes two ITO films. The reference document 4 shows an instance that provides an electrode for electrodepositing and a transparent electrode for driving, as a color filter structure formed using an electrodeposition process. FIG. 10 is a cross-sectional view of a color filter substrate 70 disclosed in the reference document 4. In this instance, the color filter substrate 70 includes an ITO film 72, as the electrode for electrodepositing, on a glass substrate 71 and an ITO film 77, as the transparent electrode for driving liquid crystals, on a BM 73 and colored layers 74 to 76.

However, in this instance, the lower ITO film (the electrode for electrodepositing) 72 is for the formation of the BM 73 or colored layers 74 to 76 by the electrodeposition process. Therefore, the lower ITO film (the electrode for electrodepositing) 72 is not connected to the upper ITO film (the transparent electrode for driving liquid crystals) 77 electrically.

### SUMMARY OF THE INVENTION

In view of the foregoing and other exemplary problems, drawbacks, and disadvantages of the related art methods and structures, the present invention provides a color filter substrate, a color liquid crystal display device using the color filter substrate, and a method for repairing the same, which makes it possible to more easily repair a defect that occurs when a foreign substance enters a display unit.

A color filter substrate according to the present invention includes a transparent substrate, a lower transparent electrode disposed on the transparent substrate, a colored layer disposed on the lower transparent electrode in a display area, and an upper transparent electrode disposed on the colored layer and electrically connected to the lower transparent electrode.

A method of repairing a color filter substrate that includes a transparent substrate, a lower transparent electrode disposed on the transparent substrate, a colored layer disposed on the lower transparent electrode in a display area, and an upper transparent electrode disposed on the colored layer to electrically connect to the lower transparent electrode according to the present invention, the method includes inspecting the colored layer and the upper transparent electrode, and removing the upper transparent electrode and the colored layer in a defect region where a defect is detected while preserving the lower transparent electrode in the region, when a defect is detected in the colored layer or the upper transparent electrode.

Accordingly, with the design and the method as described above, the color filter substrate, the color liquid crystal display device using the color filter substrate, and the method for repairing the same of the present invention produces an effect that a defect that occurs when a foreign substance enters a display unit can be easily repaired. Further, in the present invention, since the number of inspection processes can be reduced, and since it is not necessary to newly form a colored layer and an ITO film after repair, the present invention produces another effect that the number of fabrication processes can be reduced and simplified.

### BRIEF DESCRIPTION OF THE DRAWINGS

Preferred embodiments, features and advantages of the present invention will become more apparent from the following detailed description when taken in conjunction with the accompanying drawings wherein:

FIG. 1A is a partial plan view of a color filter substrate (a type of a colored layer formed in stripe) according to a first embodiment of the present invention;

FIG. 1B is a partial plan view of a color filter substrate (a type of a colored layer formed in lattice) according to a first embodiment of the present invention;

FIG. 2 is a cross-sectional view taken along the line I-I of FIG. 1A or 1B, illustrating a color filter substrate of the first embodiment before repairing the same;

FIG. 3 is a cross-sectional view taken along the line I-I of FIG. 1A or 1B, illustrating a color filter substrate of the first embodiment after repairing the same;

FIG. 4 is a flowchart of a fabrication process of the color filter substrate of the first embodiment;

FIG. 5 is a schematic diagram of a color liquid crystal display device using the color filter substrate of the first embodiment;

FIG. 6A is a plan view of a color filter substrate according to a second embodiment of the present invention;

FIG. 6B is a cross-sectional view taken along the line II-II of FIG. 6A, illustrating the color filter substrate of the second embodiment;

FIG. 7 is a cross-sectional view of a color filter substrate according to a third embodiment of the present invention;

FIG. 8 is a cross-sectional view of a color filter substrate for a conventional color liquid crystal display device;

FIG. 9 is a flowchart of a fabrication process of a conventional color filter substrate; and

FIG. 10 is a cross-sectional view of another conventional color filter substrate.

### DETAILED DESCRIPTION OF PREFERRED EMBODIMENTS

Preferred embodiments for carrying out the present invention will be described in detail below with reference to the drawings. The preferred embodiments described below show only illustrative examples in understanding the present invention, and the claims of the invention are not limited to these preferred embodiments.

A first embodiment of a color filter substrate, a color liquid crystal display device using the color filter substrate, and a method for repairing the same of the present invention will be described below.

First of all, a design of a color filter substrate according to the first embodiment of the present invention is described below in detail.

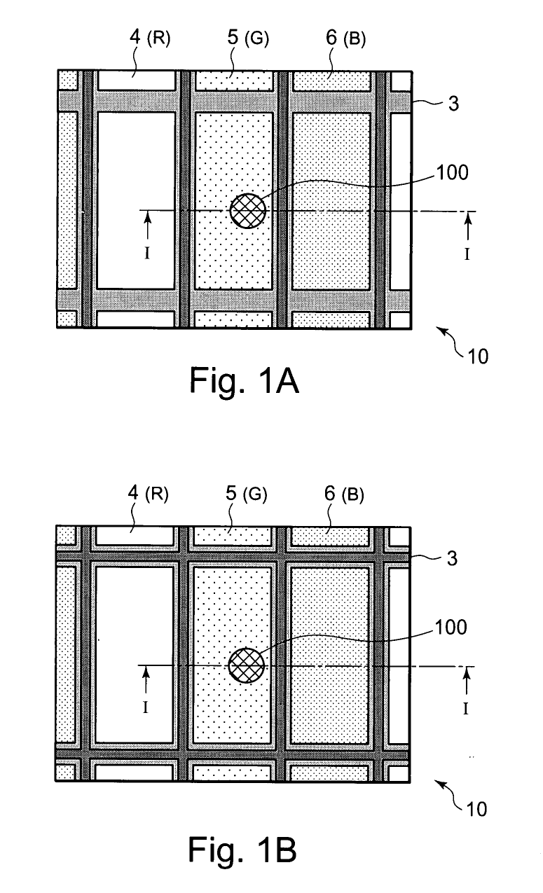

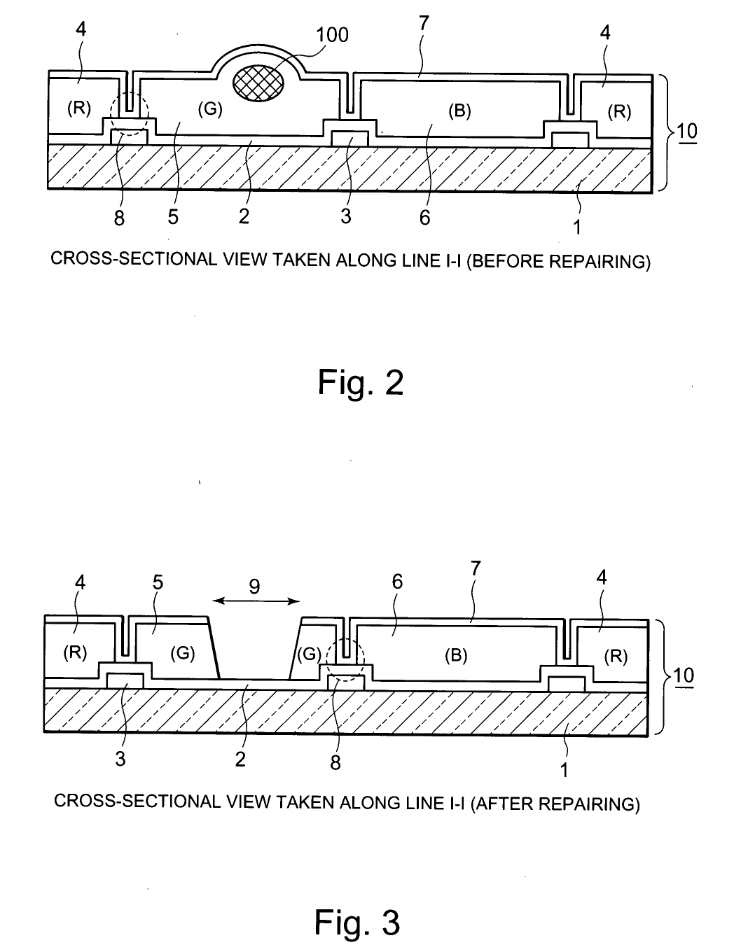

FIGS. 1A and 1B each show a partial plan view of a color filter substrate according to the first embodiment of the present invention. Further, FIG. 1A shows a type of a color filter substrate in which a colored layer is formed in stripe, and FIG. 1B shows another type of a color filter substrate in which a colored layer is formed in lattice. FIG. 2 shows a cross-sectional view taken along the line I-I of each of the color filter substrates in FIGS. 1A and 1B before repairing the same. In addition, each of these drawings shows a state in which a foreign substance has mixed into a colored layer.

In a color filter substrate 10, a black matrix (hereinafter referred to as a BM) 3 serving as a light shielding film is formed in lattice on a glass substrate 1 serving as a transparent substrate. On the color filter substrate 10, a lower ITO (Indium-Tin-Oxide) film 2 is formed as a lower transparent electrode. On that the lower ITO film 2, further, photosensitive colored resin containing pigments of red (R), green (G), and blue (B) colors is applied to that film so that colored layers 4, 5 and 6 are formed. Here, in the embodiment of FIG. 1A, the colored layers 4, 5 and 6 are patterned in stripe along the longitudinal direction of the pattern of the lattice-like BM3. On the other hand, in the embodiment of FIG. 1B, the colored layers 4, 5 and 6 are formed in an island-like pattern by conforming to the lattice-like pattern of the lattice-like BM3. Finally, over the colored layers, an upper ITO layer 7 is formed as an upper transparent electrode. As shown in FIG. 2, the upper ITO film 7 electrically contacts the lower ITO film 2 on a contacting region 8 of the BM3. In this embodiment, as an example, FIGS. 1A, 1B and 2 show a state that a foreign substance 100 is in the colored layer (G) 5.

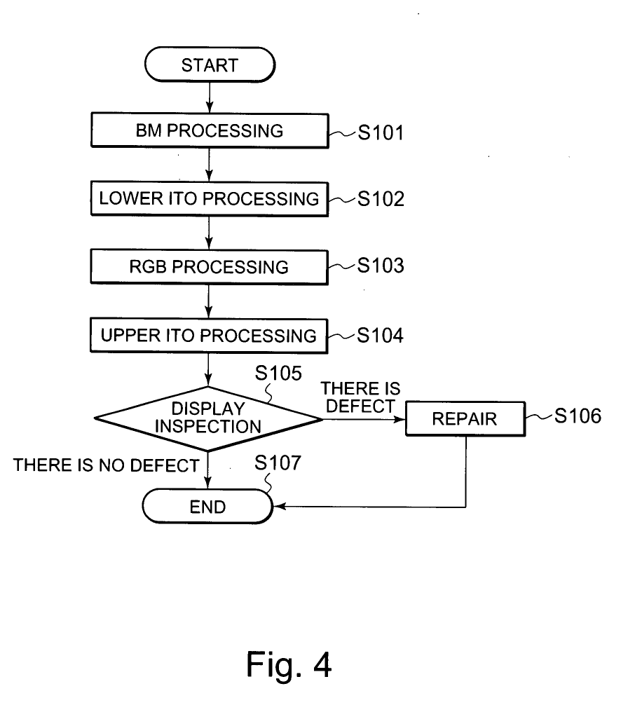

A fabrication method of a color filter substrate according to the first embodiment of the present invention is described below in detail with reference to FIGS. 1A, 1B, 2, 3 and 4. FIG. 3 shows a cross-sectional view taken along the line I-I of FIG. 1A or 1B, illustrating a color filter substrate of the first embodiment after repairing the same. FIG. 4 shows a flowchart of a fabrication process of the color filter substrate of the first embodiment.

As shown in FIG. 4, first, the lattice-like BM3 is formed on the glass substrate 1 serving as a transparent substrate using a BM processing in step S101. Next, using a lower ITO processing in step S102, the lower ITO film 2 which becomes a lower transparent electrode is formed. Then, using an RGB processing in step S103, the colored layers 4, 5 and 6 are patterned and formed in stripe as shown in FIG. 1A or in lattice as shown in FIG. 1B for respective pixels. Further, using an upper ITO processing in step S104, the upper ITO film 7 which becomes an upper transparent electrode is formed. In the process of this upper ITO processing, as shown in FIG. 2, the upper ITO film 7 and the lower ITO film 2 are electrically connected to each other in regions overlying the BM3 where the colored layers 4, 5, and 6 do not exist. Thus, the upper ITO film 7 and the lower ITO film 2 form a common electrode for a color liquid crystal display device.

As describe above, in step S103, a foreign substance may enter while forming colored layers. FIG. 2 shows a state in which a foreign substance 100 enters while forming the colored layer (G) 5 and thereby a protrusion defect occurs. The height of the protrusion occurred due to the entering of the foreign substance 100 is, for example, approximately several micrometers. When fabricating a color liquid crystal display device, such entering of a foreign substance may cause a short circuit with an electrode on a counter substrate or an interruption of emission operation of pixels. Consequently, degradation in display quality of a color liquid crystal display device may occur.

Therefore, in a display inspection (a defect inspection process) in step S105, the color filter substrate 10 is inspected. The inspection can be performed visually with eyes using a microscope by illuminating the color filter substrate 10 with a backlight. When there is no defect, the fabrication process is terminated in step S107. On the other hand, when there is a defect, a colored layer on a region where there exists the defect is repaired in step S106.

Next, a method of repairing for the defect is described in detail. As shown in FIG. 2, when the foreign substance 100 enters the colored layer (G) 5, it is confirmed in the display inspection of step S105, and repaired in step S106. As shown in FIG. 3, in a repaired region 9, the foreign substance 100, and a region of the upper ITO film 7 and the colored layer (G) 5 on the periphery of the foreign substance 100 are removed and processed, so that the lower ITO film 2 becomes an uppermost surface. In this manner, the color filter substrate 10 is repaired in step S106, and the process is terminated in step S107. The removal of the upper ITO film 7 and the colored layer (G) 5 can be performed by polishing, grinding, or the like. When considering a method in which the lower ITO film 2 is not damaged, the removal may be performed using another method such as a laser irradiation or a selective etching without limiting to the polishing and the grinding.

Thereafter, the color filter substrate 10 fabricated in the above-described way is disposed so that it faces an array substrate, and liquid crystals are injected and sealed between these substrates, thus completing a color liquid crystal display device. Further, the color liquid crystal display device is combined with a backlight, a signal substrate, and the like as needed.

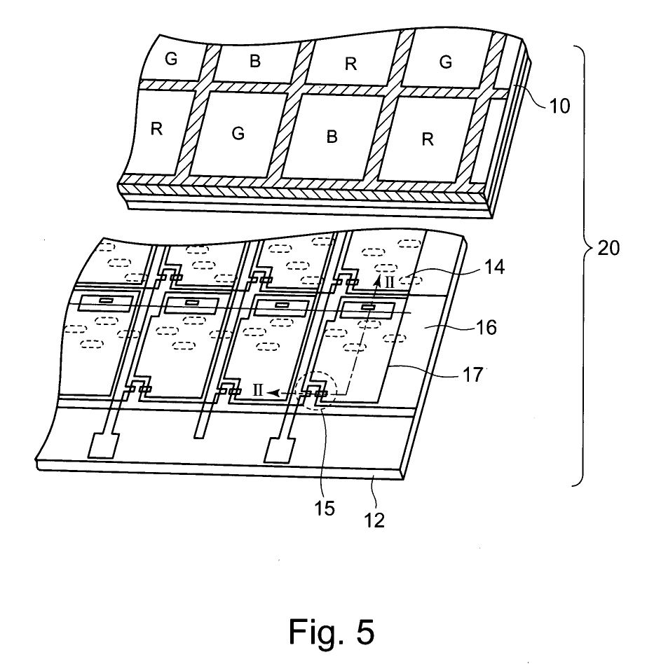

Next, the design and operations of a color liquid crystal display device according to the first embodiment of the present invention will be described. FIG. 5 shows a schematic diagram of a color liquid crystal display device using the color filter substrate according to the first embodiment of the present invention. A color liquid crystal display device 20 includes the color filter substrate 10 which is an upper substrate; an array substrate (thin-film transistor substrate) 12 which is a lower substrate disposed facing the color filter substrate 10; and a liquid crystal layer 14 filled between these substrate.

The color filter substrate 10 is formed using the above-described fabrication method to have the above-described design. On the array substrate (a thin-film transistor substrate) 12, a thin-film transistor 15 which is a switching element is arranged in matrix. Further, on the array substrate 12, wirings for selecting the thin-film transistor 15 and switching them are formed in vertical and horizontal directions, so that the wirings intersect the thin-film transistor 15. When the thin-film transistor 15 is turned on, a voltage is applied between a transparent pixel electrode 17 on a pixel area 16 of a display unit corresponding to the thin-film transistor 15, and a common electrode on the color filter substrate 10. Thus, the light transmittance of the liquid crystal layer 14 on a region applied the voltage is controlled. In that manner, the light transmittances of the respective colored layers R, G and B of the color filter substrate 10 are controlled, thus acquiring a colored image.

In the case of a liquid crystal display device of TN (Twisted Nematic) mode in which molecular orientation is twisted 90 degrees when voltage is in an off-state, a common voltage is applied to a liquid crystal layer from an ITO film of the color filter substrate 10.

Next, operations of the color filter substrate and the color liquid crystal display device according to the first embodiment of the present invention are described in detail.

When using the color filter substrate 10 on which repair is performed as shown in FIG. 3, a common voltage is applied to a normal region (for example, the colored layer (B) 6) through the upper ITO filter 7 and the lower ITO filter 2, which are electrically contacted to each other. On the other hand, on the repair region 9, since the upper ITO film 7 is removed, the common voltage is applied through the lower ITO film 2. In this manner, in the first embodiment of the present invention, the common voltage can be applied to liquid crystals on both the normal region and the repaired region.

Subsequently, described are operations in the case where the displaying of colors is performed using the color liquid crystal display device 20. In this case, the color filter substrate 10 having been repaired is used. In a state where black color is displayed on the color liquid crystal display device 20, since light is shielded due to molecular orientation of the liquid crystal layer 14, a difference in display between the repaired region and the normal region does not occur. Further, in a state where white color is displayed on the color liquid crystal display device 20, since there is no colored layer on the repaired region, white light from a backlight directly transmits therethrough. However, since the repaired region is extremely small in general, it can be said that no difference in display between the repaired region and the normal region can be visually found.

Moreover, the case is assumed where there is a repaired region on a monochromatic screen such as a red, green, or blue screen. For example, in the case where there is a repaired region in a red pixel when displaying a red screen, white light from a backlight transmits through the region. However, the white color light on the repaired region is mixed with light on a normal region. Therefore, since its visibility is quite low, it does not become a defect. On the other hand, when there is a repaired region in a colored pixel other than one to be displayed, that is, for example, when there is a repaired region in a green pixel while displaying a red screen, since light on a repaired region is shielded as in the case of a black display, no difference occurs in display between the repaired region and the normal region. In other words, even when there are defects in two pixels or more, repair can be performed in the same manner and consequently, display quality will not be significantly degraded.

The color filter substrate, the color liquid crystal display device using the color filter substrate, and the method for repairing the same according to the first embodiment of the present invention have the following effects.

The first embodiment has an effect in which the number of inspection processes is reduced. To be more precise, as shown in the flowchart of FIG. 4, the inspection process may be required a display inspection which is performed after completing a color filter substrate.

In addition, the first embodiment has an effect in which a defect region can be easily repaired. The first embodiment further has an effect in which the number of fabrication processes can be reduced. To be more precise, as described above, repair may be performed by only removing a foreign substance on a defect region, an upper ITO film and a colored layer on that region. Thus, it is not necessary to newly form the colored layer and the upper ITO film. Particularly, when there is a defect on a plurality of colored layers, since it is not necessary to newly form the plurality of colored layers, the fabrication process can be simplified. Thus, the above-described effects can be enhanced.

Additionally, the first embodiment further has an effect in which, in addition to a defect occurred at the time of processing the colored layer, a defect occurred at the time of processing the upper ITO film can be also easily repaired.

Further, the above-described effects of the first embodiment may produce an effect in which cost can be prevented from increasing.

Subsequently, a color filter substrate according to a second embodiment of the present invention will be described below.

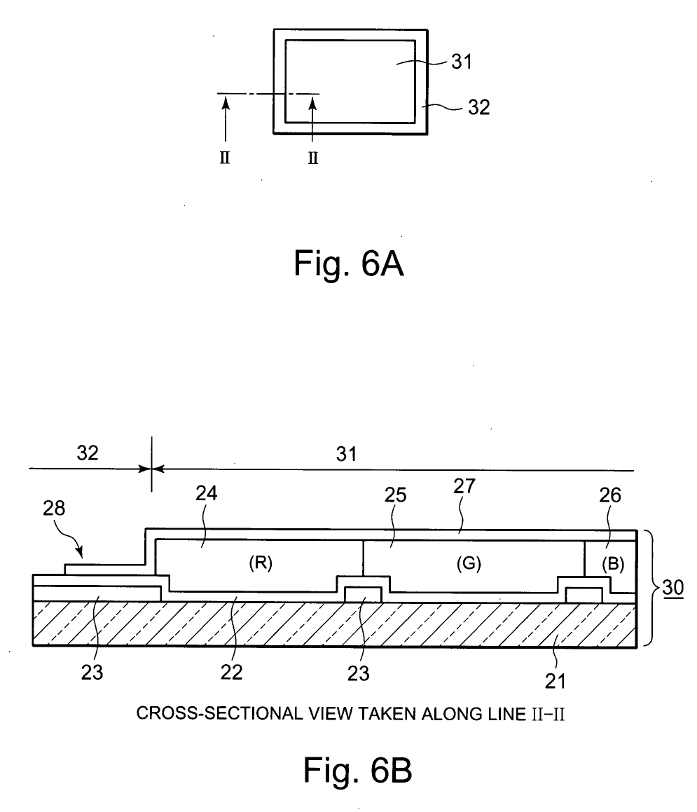

FIG. 6A shows a plan view of a color filter substrate according to a second embodiment of the present invention. FIG. 6B shows a cross-sectional view taken along the line II-II of FIG. 6A.

In the first embodiment shown in FIG. 2, a connection between the upper ITO film and the lower ITO film is established on the BM in the display unit within a pixel area. On the other hand, as shown in FIG. 6B, in the second embodiment, an upper ITO film 27 and a lower ITO film 22 do not have a structure in which these films 27 and 22 are electrically connected to each other within a display unit 31, which is a pixel area. Instead of that, the upper ITO film 27 and the lower ITO film 22 have a structure in which these films 27 and 22 are electrically connected to each other in a connection part 28 in a peripheral part 32 of the display unit 31. Thus, the upper ITO film 27 and the lower ITO film 22 form a common electrode.

In this second embodiment also, repair is performed using the same design and fabrication method as those of the first embodiment. To be more precise, the upper ITO film 27 and a colored layer (G) 25, which are located on the periphery of a foreign substance, are removed along with the foreign substance when the foreign substance enters the colored layer (G) 25. Thereby, processing is performed so that the lower ITO film 22 becomes an uppermost surface. Thus, to a normal region, a common voltage is applied through the upper ITO film 27 and the lower ITO film 22; and, to a repaired region, the common voltage is applied through the lower ITO film 22.

This second embodiment also has the same effects as those of the first embodiment. Further, in the second embodiment, it is not necessary to provide a contact part on a BM 23. Therefore, this second embodiment is effective when the colored layers 24 to 26 are closer to each other by narrowing the wide of the BM 23, or when a secure connection between the upper ITO film 27 and the lower ITO film 22 is acquired.

Next, a color filter substrate according to a third embodiment of the present invention will be described below.

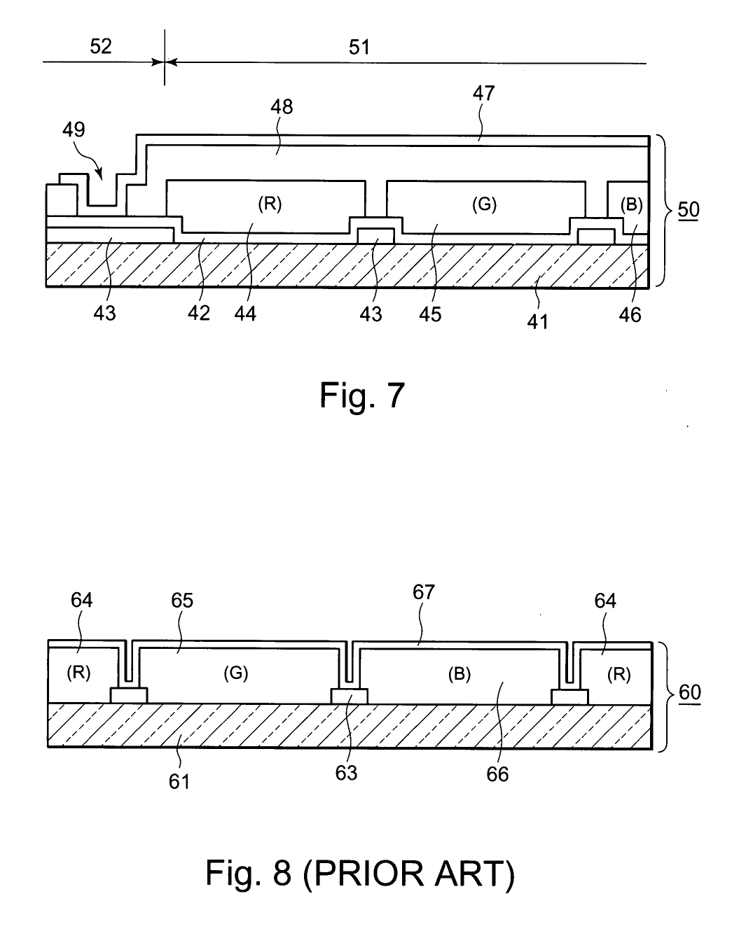

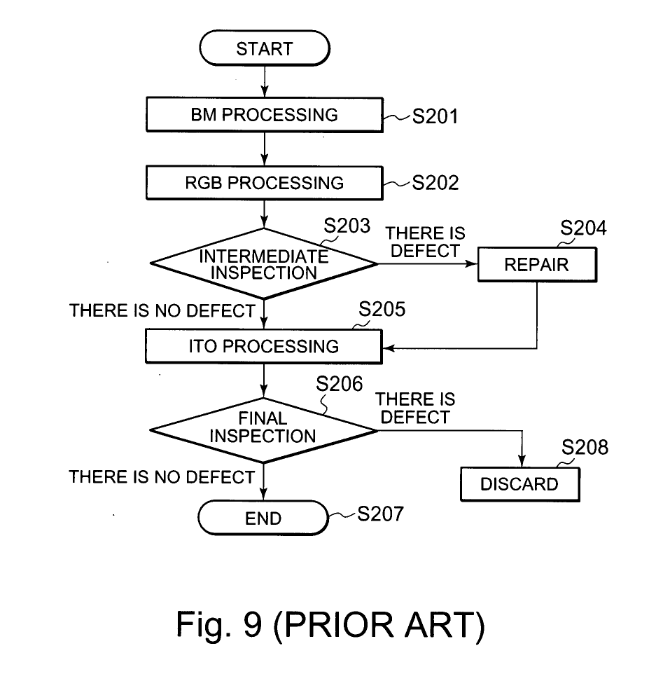

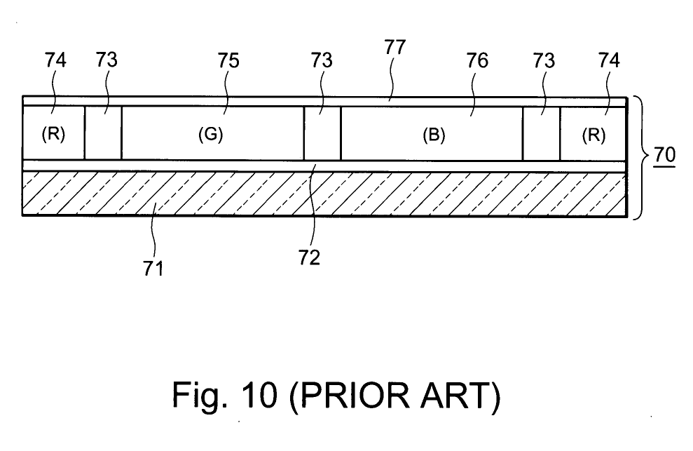

FIG. 7 shows a cross-sectional view of a color filter substrate of the third embodiment. In this third embodiment, an overcoat layer 48 is formed over colored layers 44 to 46 so as to flatten the surface. The material of the overcoat layer 48 is usually photo-curing resin or heat-curing resin. When using photo-curing resin, a through-hole for connection can be easily formed at a specific position. Thus, in this third embodiment, an upper ITO film 47 and a lower ITO film 42 are connected to each other by using the through-hole. To be more precise, a through-hole part 49 is formed on the overcoat layer 48 on a peripheral part 52 as shown in FIG. 7; and the upper ITO film 47 and the lower ITO film 42 are electrically connected to each other in this through-hole part 49.

In this third embodiment also, repair is performed using the same design and fabrication method as those of the first embodiment. To be more precise, the upper ITO film 47, the overcoat layer 48, and a colored layer (G) 45, which are located on the periphery of a foreign substance, are removed along with the foreign substance when the foreign substance enters the colored layer (G) 45. Thereby, processing is performed so that the lower ITO film 42 becomes an uppermost surface. Thus, to a normal region, a common voltage is applied through the upper ITO film 47 and the lower ITO film 42; and, to a repaired region, the common voltage is applied through the lower ITO film 42.

In the third embodiment also, the upper ITO film 47 and the lower ITO film 42 are easily connected to each other in a color filter substrate 50 having the overcoat layer 48. Thus, the third embodiment also has the same effects as those of the other above-described embodiments.

Further, in an example of FIG. 7, the through-hole part 49 is formed on the peripheral part 52. At the same time, a through-hole may be formed on a BM 43 in a display unit 51, so that the upper ITO film 47 and the lower ITO film 42 are connected to each other in the through-hole.

As described above, the color filter substrate, and the method for repairing the same in the second and third embodiments are explained. At the same time, a color liquid crystal display device using such a color filter substrate is also directed to the present invention as in the case of the first embodiment.

Color liquid crystal display devices tend to be increasingly low in price, large in screen, and defect-free. As described above, the color filter substrate of the present invention can be easily repaired, and has the less number of inspection processes so that fabrication cost can be reduced. Thus, by using the color filter substrate of the present invention, a color liquid crystal display device, which meets the above-described requirements, can be realized.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended later during prosecution.

What is claimed is:

1. A color filter substrate comprising:
a transparent substrate;
a lower transparent electrode disposed on the transparent substrate;
a colored layer disposed on the lower transparent electrode in a display area; and
an upper transparent electrode disposed on the colored layer and electrically connected to the lower transparent electrode.

2. The color filter substrate according to claim 1, further comprising a black matrix formed between the transparent substrate and the lower transparent electrode, wherein
the upper transparent electrode is electrically connected to the lower transparent electrode in regions overlying the black matrix.

3. The color filter substrate according to claim 1, wherein the upper transparent electrode is electrically connected to the lower transparent electrode in a peripheral part of the display area.

4. The color filter substrate according to claim 1, wherein the upper transparent electrode and the lower transparent electrode form a common electrode.

5. The color filter substrate according to claim 1, further comprising a repaired region that portions of the upper transparent electrode and the colored layer have been removed, and that the lower transparent electrode is exposed.

6. The color filter substrate according to claim 1, further comprising an overcoat layer between the colored layer and the upper transparent electrode.

7. The color filter substrate according to claim 6, wherein the upper transparent electrode is electrically connected to the lower transparent electrode in a through-hole part formed in the overcoat layer.

8. The color filter substrate according to claim 1, wherein the colored layer comprises red, green and blue colored layers.

9. The color filter substrate according to claim 1, wherein the lower transparent electrode and the upper transparent electrode contain indium-tin-oxide.

10. A color liquid crystal display device comprising:
the color filter substrate according to claim 1;
an array substrate disposed so that the array substrate faces the color filter substrate; and
a liquid crystal layer filled and sealed between the color filter substrate and the array substrate.

11. The color liquid crystal display device according to claim 10, wherein the array substrate includes a plurality of thin-film transistors disposed in an array.

12. The color liquid crystal display device according to claim 10, wherein the liquid crystal layer comprises nematic liquid crystal.

13. A method of repairing a color filter substrate that includes a transparent substrate; a lower transparent electrode disposed on the transparent substrate; a colored layer disposed on the lower transparent electrode in a display area; and an upper transparent electrode disposed on the colored layer to electrically connect to the lower transparent electrode, said method comprising:
inspecting the colored layer and the upper transparent electrode; and
removing the upper transparent electrode and the colored layer in a defect region where a defect is detected while preserving the lower transparent electrode in the region, when a defect is detected in the colored layer or the upper transparent electrode.

14. The method according to claim 13, wherein said method is performed upon completion of a manufacturing process comprising:
forming the lower transparent electrode on the transparent substrate;
forming the colored layer on the lower transparent electrode; and
forming the upper transparent electrode on the colored layer so that the upper transparent electrode is electrically connected to the lower transparent electrode.

15. The method according to claim 14, wherein the manufacturing process further comprises forming a black matrix between the transparent substrate and the lower transparent electrode, wherein
the upper transparent electrode is electrically connected to the lower transparent electrode in regions overlying the black matrix.

16. The method according to claim 14, wherein the upper transparent electrode is electrically connected to the lower transparent electrode in a peripheral part of the display area.

17. The method according to claim 14, wherein the manufacturing process further comprises forming an overcoat layer between the colored layer and the upper transparent electrode, wherein
the upper transparent electrode is electrically connected to the lower transparent electrode in a through-hole part formed in the overcoat layer.

18. The method according to claim 13, wherein the upper transparent electrode and the lower transparent electrode are supplied with a common voltage.

19. The method according to claim 13, wherein the upper transparent electrode in the defect region and the colored layer there beneath are removed by polishing or grinding.

20. The method according to claim 14, wherein the manufacturing process further comprising:
disposing an array substrate so that the array substrate faces the color filter substrate; and
filling and sealing a liquid crystal layer between the color filter substrate and the array substrate.
